(19) United States
(12) Patent Application Publication
(10) Pub. No.: US 2026/0330811 A1
(43) Pub. Date: Oct. 22, 2026

(54) BOOSTING UNDERPERFORMING CLASSES USING SYNTHETIC DATA

(71) Applicant: SAP SE, Walldorf (DE)

(72) Inventors: Ankush Mishra, Singapore (SG); Rahul George, Singapore (SG); Rajesh Vellore Arumugam, Singapore (SG); Anantharaman Ravi, Singapore (SG)

(21) Appl. No.: 19/184,605

(22) Filed: Apr. 21, 2025

(51) Int. Cl. G06V 10/774; G06V 10/764; G06V 10/776; G06V 10/82

(52) U.S. Cl. CPC G06V 10/774; G06V 10/764; G06V 10/776; G06V 10/82

(57) ABSTRACT

Systems and methods described herein relate to data expansion techniques for machine learning. A classification model is trained on an initial dataset and a classification accuracy for the model is determined for each class. A generative model generates high-resolution candidate images based on images in the initial dataset. Candidate images are selected based on an accuracy of the classification model for each class, such that more candidate images are selected for lower-performing classes than for higher-performing classes. The selected candidate images are added to the initial dataset to create a modified dataset. The modified dataset is used to retrain the classification model, thereby resulting in an improved version of the classification model.

### TECHNICAL FIELD

The subject matter disclosed herein generally relates to data expansion technologies for use in machine learning. Particularly, but not exclusively, the subject matter relates to techniques for the creation and validation of synthetic data using generative artificial intelligence (AI).

### BACKGROUND

Many computer vision systems rely on machine learning models to perform tasks such as image classification and object detection.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment suitable for use in boosting underperforming classes using synthetic data, according to some examples.

FIG. 2 is a block diagram illustrating components of a dataset expansion system and components of a machine learning system, according to some examples.

FIG. 3 is a block diagram illustrating components of a neural network, according to some examples.

FIG. 4 is a diagrammatic representation of a dataset expansion pipeline, according to some examples.

FIG. 5 is a block diagram illustrating components of a machine learning system, according to some examples.

FIG. 6 is a flowchart illustrating a machine learning pipeline, according to some examples.

FIG. 7 is a system architecture diagram showing a layered view of an AI integrated system, according to some examples.

FIG. 8 is a flowchart illustrating a method of boosting underperforming classes using synthetic data, according to some examples.

FIG. 9 is a flowchart illustrating a method of boosting underperforming classes using synthetic data, according to some examples.

FIG. 10 is a block diagram of a computing system, according to some examples, within which instructions may be executed to perform one or more of the methodologies discussed herein.

FIG. 11 is a block diagram of a computing system, according to some examples, within which instructions may be executed to perform one or more of the methodologies discussed herein.

### DETAILED DESCRIPTION

Advances in computer vision have revolutionized tasks like image classification and object detection. However, achieving robust performance across all classes in a dataset remains a challenge, particularly when faced with underrepresented or visually complex categories. These shortcomings often arise due to limited high-quality data for such classes, resulting in biased models with uneven predictive capabilities.

Large and diverse datasets are often needed for training effective computer vision models. For example, an image classifier model can learn, based on a training dataset of images with corresponding class labels, to classify input images as “defective” (e.g., the image shows a defective product) or “non-defective” (e.g., the image shows a product with no visible defects).

If datasets are too small or overly imbalanced, computer vision models may struggle to learn robust features or generalize effectively to new or varied inputs. Obtaining suitable datasets can be challenging, especially when limited real-world data is available (e.g., due to the limited presence of certain class labels, annotation challenges, data access restrictions, or privacy concerns). For example, the training dataset for the aforementioned image classifier model might contain only one or two defective samples for every 10,000 or 20,000 non-defective samples. This scarcity can limit the ability of a computer vision model to generalize, leading to technical problems such as overfitting, poor feature learning, or reduced reliability when encountering new or varied inputs. Addressing this issue is critical to ensuring fair and reliable applications of computer vision, particularly in domains where errors in underrepresented classes can have significant consequences, such as industrial defect detection.

Existing approaches often attempt to overcome this limitation by using data augmentation techniques or transfer learning to improve model generalization. While these methods provide marginal improvements, they frequently fail to address the root cause: the lack of diverse and high-quality samples for underperforming classes. Current augmentation strategies typically introduce synthetic data indiscriminately, risking data distribution shifts that may degrade model performance instead of enhancing it. This underscores a crucial research gap in developing adaptive, class-specific data augmentation pipelines that focus on addressing the most challenging categories while maintaining overall dataset consistency.

Accordingly, disclosed herein is an innovative two-phase architecture to enhance downstream model performance by generating synthetic images. In various example embodiments, one or both phases are used. In a first phase, diverse high-resolution samples for all classes are generated (e.g., using a Stable Diffusion model). These synthetic samples are curated to ensure compatibility with the original dataset, augmenting it without introducing distributional shifts. In a second phase, underperforming classes are identified using task-specific performance metrics, and targeted augmentation is applied. Through iterative refinement, the retrained model achieves improved generalization across all classes, effectively bridging performance gaps with a targeted, data-driven augmentation strategy.

Synthetic image generation is a technique for data augmentation. Synthetic image generation typically involves creating artificial images using one or more computational processes. This can enhance datasets by introducing novel variations, thereby improving feature diversity. Further, synthetic image generation can address dataset imbalances to enable a computer vision model to learn better from underrepresented classes or handle complex scenarios that might otherwise be overlooked.

Examples in the present disclosure facilitate in-domain data expansion for the training of computer vision models. In some examples, a system according to the present disclosure leverages a generative model (e.g., a diffusion model) for data augmentation and employs a distribution-aware image synthesizing process to ensure class-specific image generation.

A computing system can perform a computer-implemented method to augment an initial dataset in a class-aware manner. In some examples, the initial dataset includes a collection of labeled images used for training machine learning models. In some examples, the initial dataset contains images with corresponding class labels that represent different categories or conditions, such as defective and non-defective samples in manufacturing applications. The initial dataset may include real data, synthetic data, or combinations thereof.

The initial dataset may be imbalanced, with some classes having significantly fewer examples than others. Accordingly, the generation of synthetic data may favor the underrepresented classes to improve results from a machine learning model trained using the dataset.

The method may include accessing a plurality of input images from a data source and generating candidate images for each input image. In some examples, the data source is the initial dataset. The specific number of candidate images generated for each input image may vary. In some examples, this number is between two and ten. In some examples, the number of candidate images is the same for each input image. In other examples, the system applies different numbers for different input images (e.g., to dynamically control class distribution).

For each input image, a filtering operation can be performed on the plurality of candidate images to obtain validated images. The filtering operation can assess each candidate image and its corresponding reconstructed image. In some examples, the filtering process includes removing certain candidate images based on their dissimilarity when compared to their corresponding reconstructed images. The filtering process may include generating a value, such as a perceptual distance score, that indicates the similarity between each candidate image and its corresponding reconstructed image. This value may then be compared against a predetermined threshold to determine whether the candidate image should be removed.

The method may include storing an expanded dataset that comprises both the initial dataset and the validated images associated with each of the input images. In some examples, where the initial dataset is an imbalanced classification dataset, the method may compensate for this imbalance by dynamically controlling the selection of input images from a data source, the number of candidate images generated from the input images, selection of candidate images for incorporation into the dataset, or any suitable combination thereof. This may include oversampling from one or more minority classes present in the initial dataset to increase their proportion in the expanded dataset.

The expanded dataset may thus include a combination of the initial dataset and validated synthetic images generated through the data expansion process. In some examples, the expanded dataset is created by combining the original images with synthetic images that have passed distribution alignment validation. In some cases, only a subset of data from the initial dataset is combined with the validated synthetic data to form the expanded dataset. In some examples, the expanded dataset maintains class labels for images.

The method may include training a model on the expanded dataset. For example, the expanded dataset is used by a computing system to train an image classifier model to predict whether a depicted product has a defect.

Examples in the present disclosure provide a system and method for automatically adding relevant training data, enhancing diversity in training data, or both, when faced with a limited or unsatisfactory set of initial data. By creating synthetic samples, the system can improve the representation of minority classes, reducing dominance of majority classes and mitigating class imbalance. An expanded dataset produced through this approach can be leveraged to retrain a classifier model to bolster its capabilities or to train a new classifier model based on data with reduced biases compared to the original data. In some examples, the technology of the present disclosure allows for dynamic adjustment of parameters, such as the number of synthetic images generated per input and the similarity threshold used for filtering.

The present disclosure provides various technological solutions to technological challenges. One technological challenge when generating synthetic images to be added to an original dataset is that of alignment with the original dataset distribution. Generated images can suffer from distribution shifts and model hallucinations, where the generative model produces images that deviate significantly from the target domain's characteristics. The technological challenge can be addressed or alleviated using approaches described herein. For example, the system produces synthetic data conditioned on sample class, reducing distribution shifts and ensuring alignment with the original dataset. Furthermore, the system applies automatic filtering for distribution control.

A further technological challenge is that of learning robust features when trained on limited datasets. The scarcity of diverse examples, particularly in minority classes, can create a technical barrier to effective feature extraction and representation learning. This results in poor generalization capabilities and reduced reliability when the model encounters new or varied visual inputs.

Examples in the present disclosure address this technological challenge by enhancing data diversity. In some examples, the system implements dynamic data expansion controls. For imbalanced classification datasets, the system automatically compensates by controlling either the selection of input images from the data source or adjusting the number of candidate images generated from input images. The system can oversample from minority classes to increase their proportion in the expanded dataset, thereby automatically generating novel variations for minority classes and reducing overfitting on majority classes. The expanded dataset, comprising both the initial dataset and validated synthetic images, provides additional diverse examples for training while maintaining distribution alignment through the class-aware generation process.

The subject matter of the present disclosure provides concrete technical improvements to computer vision systems. The technology described herein provides measurable performance gains, including downstream improvements to classification accuracy. Model performance in limited-data scenarios can be boosted by generating class-specific, relevant samples, with such samples introducing feature diversity and enhancing dataset richness. The technology described herein further demonstrates improved robustness in computer vision systems through its distribution-aware validation mechanism.

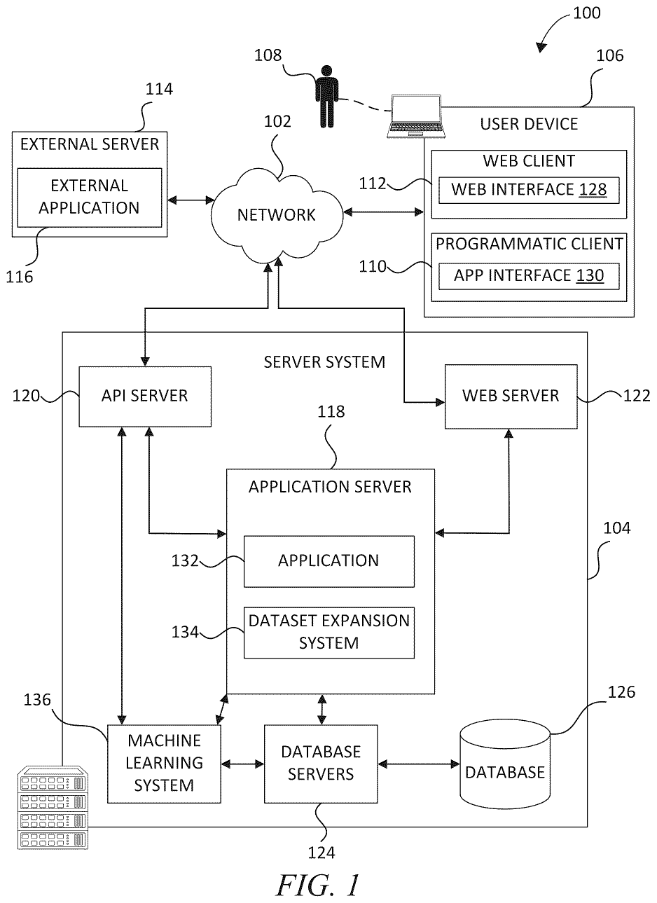

FIG. 1 is a diagrammatic representation of a networked computing environment 100 suitable for use in boosting underperforming classes using synthetic data. One or more servers in a server system 104 provide server-side functionality via a network 102 to a networked device, in the example form of a user device 106 that is accessed by a user 108. A web client 112 (e.g., a browser) or a programmatic client 110 (e.g., an “app”) may be hosted and executed on the user device 106.

An Application Programming Interface (API) server 120 and a web server 122 provide respective programmatic and web interfaces to components of the server system 104. An application server 118 hosts an application 132 and a dataset expansion system 134, each of which can include one or more components, modules, or applications. In some examples, multiple different application servers can be employed for this purpose.

The user device 106 can communicate with the application server 118 via the web interface supported by the web server 122 or via the programmatic interface provided by the API server 120. It will be appreciated that, although only a single user device 106 is shown in FIG. 1, a plurality of user devices may be communicatively coupled to the server system 104.

The application server 118 is communicatively coupled to a machine learning system 136. The application server 118 is further communicatively coupled to database servers 124, facilitating access to one or more information storage repositories, such as a database 126. In some examples, the database 126 includes storage devices that store information to be processed by the application 132, the dataset expansion system 134, or the machine learning system 136. The information may include machine learning model training data.

The application server 118 accesses application data (e.g., application data stored by the database servers 124) to provide one or more applications, features, or software tools to the user device 106 via a web interface 128 or an app interface 130. The application 132 is an example of an application that can be provided to the user device 106.

For example, in a manufacturing context, the application 132 provides features of a defect inspection system. The defect inspection system is communicatively coupled to various manufacturing facilities (or other related facilities, such as assembly facilities or quality control facilities) to provide digital manufacturing tools or services. At the facility level, various sensors or devices can collect data as part of a production process. These sensors or devices can be connected to local controllers, which may perform initial data processing and aggregation (at least in some examples). Data is then transmitted to the server system 104, allowing for one or more functions to be performed, such as defect inspection, analytics, reporting, or integration with other processes. For instance, the database 126 remotely stores input data collected by local sensors, and the defect inspection system applies machine learning algorithms to analyze the data, and further uses the results to determine which actions to perform or trigger. To this end, the application 132 may provide one or more dashboards via a graphical user interface (GUI) on the user device 106, such as a dashboard that summarizes inspection results or allows the user 108 to provide feedback or exercise control over certain aspects of such inspections.

It is noted that while manufacturing (e.g., product defect detection in a manufacturing context) is used to describe certain examples in the present disclosure, such as an example of the application 132 of FIG. 1, the described techniques of the present disclosure can be applied across various domains and classification tasks. In other words, various techniques described herein are not limited to manufacturing environments or defect classification applications, and can also be applied to other types of systems involving datasets that may benefit from synthetic samples with, for example, high fidelity, diversity, and alignment with an original data distribution.

The machine learning system 136 can provide machine learning models used for generating predictions within automated processes (e.g., to generate a prediction as to whether an inspected item is “defective” or “non-defective” or generate a prediction of a defect type). The machine learning system 136 may provide various capabilities, such as training models, deploying predictions, and monitoring performance. The machine learning system 136 may leverage training datasets (e.g., stored in the database 126) to construct machine learning pipelines and train or re-train (e.g., adjust) machine learning models used by the defect inspection system associated with the application 132.

The dataset expansion system 134 is an example of a tool that can be provided to the user device 106. The dataset expansion system 134 is configured to enable expansion of datasets. For example, the dataset expansion system 134 can be used by the user 108 to trigger the adding of data items to an initial dataset to create an expanded dataset to be used by the machine learning system 136 for model training. As an example, the expanded dataset might be a collection of images with class labels indicating whether a product is defective. The expanded dataset is then used to train or adjust a computer vision model for use in the context of the application 132.

The dataset expansion system 134 may also provide one or more dashboards via a graphical user interface (GUI) on the user device 106, such as a dashboard that enables a user 108 to control settings of the data expansion pipeline. For instance, the user 108 might use the GUI of the dataset expansion system 134 via the web interface 128 or the app interface 130 to select a data source for input images to be fed into the data expansion pipeline, to select the number of candidate images to be generated for each input image, to control validation or filtering thresholds of the dataset expansion system 134, or to view expansion process results.

In some examples, the dataset expansion system 134 operates as a comprehensive framework for expanding limited datasets while maintaining data distribution alignment. The dataset expansion system 134 includes various components that work together to generate and validate synthetic images. The dataset expansion system 134 may interface with the machine learning system 136 to coordinate the data expansion process. For example, the dataset expansion system 134 can use trained models that are executed by the machine learning system 136 as part of a data expansion pipeline.

In some examples, the application server 118 is part of a cloud-based platform provided by a software provider that allows the user 108 to utilize the application 132 or the dataset expansion system 134. For example, an account holder may access one or more cloud instances to communicate with the application 132 or the dataset expansion system 134.

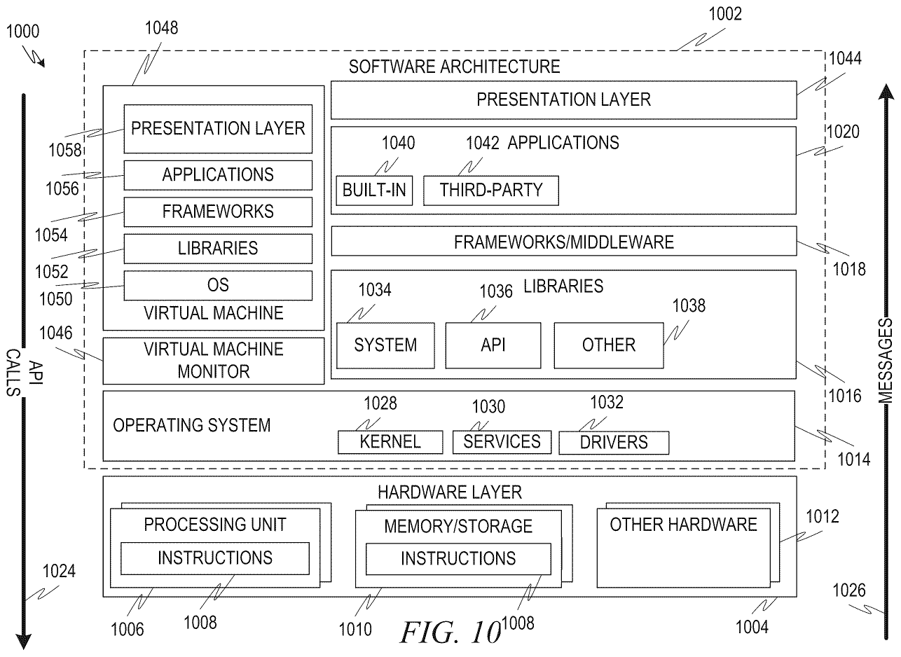

One or more of the application server 118, the database servers 124, the API server 120, or the web server 122 may each be implemented in a computer system, in whole or in part. This can include, for example, a computing environment as described below with respect to FIG. 10. In some examples, external applications, such as an external application 116 executing on an external server 114, can communicate with the application server 118 via the programmatic interface provided by the API server 120. For example, a third-party application may support one or more features or functions on a website or platform hosted by a third party, or may perform certain methodologies and provide input or output information to the application server 118 for further processing or publication.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

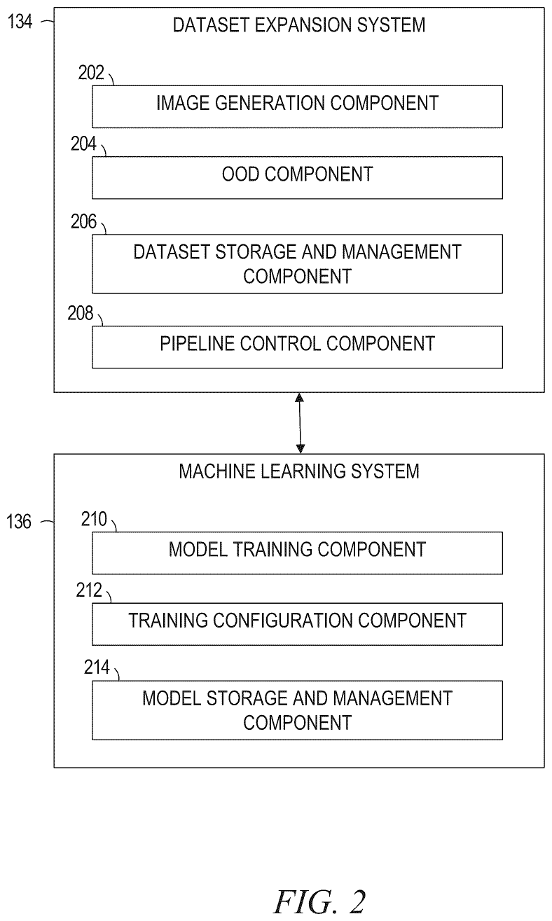

FIG. 2 is a block diagram illustrating components of the dataset expansion system 134 of FIG. 1 and components of the machine learning system 136 of FIG. 1, according to some examples. In FIG. 2, the dataset expansion system 134 is shown to include an image generation component 202, an out-of-distribution (OOD) detection component 204, a dataset storage and management component 206, and a pipeline control component 208. The machine learning system 136 is shown to include a model training component 210, a training configuration component 212, and a model storage and management component 214.

Referring firstly to the dataset expansion system 134, the image generation component 202 of the dataset expansion system 134 is configured to generate synthetic images based on input images and their respective class labels. In some examples, the image generation component 202 leverages a generative model accessible via the machine learning system 136 to generate synthetic images. A diffusion model (e.g., Stable Diffusion) is an example of such a generative model. In some examples, the generative model is trained on an initial dataset that is intended to be expanded.

The image generation component 202 performs class-aware image generation. In some examples, in addition to conditioning image generation on class, the image generation component 202 detects or predicts the relevant class label for each input image before performing the image generation process. For example, the image generation component 202 leverages an image classifier model accessible via the machine learning system 136 to predict class labels. A residual network (ResNet) and a Vision Transformer (ViT) are examples of such image classifier models. In some examples, the image classifier model is also trained on the initial dataset that is intended to be expanded.

The OOD detection component 204 is responsible for automatically checking generated images to ensure they remain within an original data distribution or are likely to be within such distribution. In some examples, the OOD detection component 204 performs masking and reconstruction operations to identify potential OOD samples. For example, the OOD detection component 204 applies a mask to each candidate image and then automatically reconstructs the masked image to obtain a reconstructed image. The OOD detection component 204 then compares the reconstructed image with the original candidate image. If the reconstructed image is not sufficiently similar to the original candidate image, the OOD detection component 204 flags the candidate image as OOD.

Image reconstruction may involve image inpainting, also referred to as image completion. In this context, inpainting refers to the addition, by a computerized process, of new content to an image in specified regions. For example, the OOD detection component 204 runs the same generative model that generated the initial candidate image to reconstruct a masked version of the candidate image. In this way, the generative model automatically fills “missing” regions in the image by attempting to harmonize such regions with the other portions of the image.

Various types of masks can be applied. In one example implementation, during operation, the OOD detection component 204 randomly applies one of two complementary “checkered” masking templates. For instance, one pattern resembles a chess board and masks certain square regions while leaving others visible, and the second pattern is the inverse —masking the squares that are visible in the first pattern while revealing the ones that are masked in the first pattern. Each of these patterns ensure coverage of the image while maintaining structural information, allowing the dataset expansion system 134 to verify reconstruction quality across the entire image.

The OOD detection component 204 can apply a threshold to determine whether to filter out OOD candidate images. For example, the OOD detection component 204 calculates a perceptual distance score between each candidate image and its reconstruction, and filters out the candidate image if the perceptual distance score exceeds a predetermined threshold.

One example of a perceptual distance scoring technique is the Learned Perceptual Image Patch Similarity (LPIPS) technique. LPIPS is a measure of dissimilarity that has been shown to correlate with human perception of similarity. LPIPS calculates perceptual similarity between two images. A lower score means that images are more similar, while a higher score means that images are less similar.

In one example implementation, the predetermined threshold is set at 0.05. Thus, for example, if the LPIPS score exceeds 0.05, a candidate image is too dissimilar from its reconstructed version and is not validated by the OOD detection component 204. On the other hand, if the LPIPS score is equal to or less than 0.05, the candidate image is validated and can, for example, be used to expand the initial dataset. In the latter case, the OOD detection component 204 applies the principle that a candidate image with acceptable perceptual similarity is likely to conform to the distribution of the target dataset (e.g., the initial dataset to be expanded) and its addition thereto may result in a higher quality trained model.

In addition to or instead of LPIPS, a Structural Similarity Index (SSIM) may be used. The Structural Similarity Index (SSIM) is a perceptual metric used to measure the similarity between two images based on luminance, contrast, and structure. Unlike simple pixel-by-pixel comparison methods, SSIM better aligns with human visual perception by considering the interdependence of nearby pixels.

Accordingly, in some examples, the OOD detection component 204 serves as a quality control component, identifying and removing candidate images from those generated by the image generation component 202 if they are too dissimilar, or OOD, compared to the initial dataset on which the generative model was trained. As mentioned, the same generative model that generates the candidate image can be used to validate that candidate image. This approach leverages the principle that a generative model, such as a diffusion model, can often effectively reconstruct images within the distribution it is trained on but encounters difficulties with OOD samples.

The dataset storage and management component 206 of the dataset expansion system 134 maintains data items forming part of datasets. In some examples, the dataset storage and management component 206 stores validated in-domain images that pass filtering criteria along with their associated class labels. The dataset storage and management component 206 can define an expanded dataset by combining original data items with additional data items that are validated by the OOD detection component 204.

In some examples, the dataset storage and management component 206 deletes or otherwise removes candidate images that do not pass the filtering stage. The dataset storage and management component 206 may also be configured to delete intermediate images, such as masked images, reconstructions, or other intermediate outputs (e.g., raw outputs from a generative model that are further processed to generate reconstructions), once they are no longer needed, thereby freeing up memory resources.

The pipeline control component 208 may coordinate an overall dataset expansion workflow. For example, the pipeline control component 208 manages the sequential process of generation, validation, and filtering of synthetic images. The pipeline control component 208 may dynamically adjust parameters such as the number of candidate images generated based on dataset characteristics (e.g., class imbalance). In some examples, the pipeline control component 208 receives and acts upon user input to control the workflow. For example, a user (e.g., the user 108 of FIG. 1) may provide input (e.g., via the user device 106) to adjust the threshold to be applied when using the perceptual distance score for validation.

Referring now to the machine learning system 136 as shown in FIG. 2, the machine learning system 136 provides underlying model infrastructure and training capabilities that support the data expansion process. In some examples, the machine learning system 136 manages both a generative model and a classifier model used in the expansion pipeline.

The model training component 210 of the machine learning system 136 handles the training of machine learning models used in the data expansion process. In some examples, the model training component 210 manages the supervised training of the generative model and the image classifier model, or both, on an initial dataset (e.g., the original dataset or target dataset to be expanded). In some examples, the model training component 210 also handles downstream training based on an expanded dataset. For example, once the expanded dataset has been generated using the initial dataset and the additional, validated candidate images (along with their class labels), the model training component 210 triggers training of a selected model (e.g., a binary or multiclass classifier) using the expanded dataset.

The training configuration component 212 manages various parameters and settings used during model training. This includes, for example, hyperparameters such as learning rates, batch sizes, and optimization algorithms that affect how models learn from the training data. The training configuration component 212 can dynamically adjust these parameters based on training progress and performance metrics to achieve optimal results.

The model storage and management component 214 maintains and organizes trained models and their associated data. For example, the model storage and management component 214 handles version control of models, tracks model lineage and training history, and ensures proper alignment between models and their corresponding training datasets. In some examples, the model storage and management component 214 interfaces with the dataset storage and management component 206 to maintain consistency between the models and the data used to train them, enabling effective model governance and reproducibility of results.

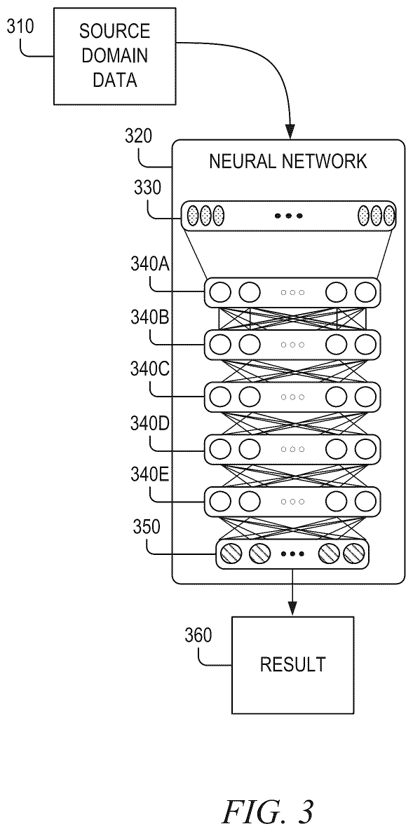

FIG. 3 is a block diagram illustrating components of a neural network 320, according to some examples. The neural network 320 takes source domain data 310 as input, processes the source domain data 310 using the input layer 330; the intermediate, hidden layers 340A, 340B, 340C, 340D, and 340E; and the output layer 350 to generate a result 360.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training dataset for several epochs (e.g., iterations), in which the training dataset is repeatedly fed into the model to refine its results. For example, in a supervised learning phase, a model is developed to predict the output for a given set of inputs and is evaluated over several epochs to more reliably provide the output that is specified as corresponding to the given input for the greatest number of inputs for the training dataset. In another example, for an unsupervised learning phase, a model is developed to cluster the dataset into n groups and is evaluated over several epochs as to how consistently it places a given input into a given group and how reliably it produces the n desired clusters across each epoch.

Once an epoch is run, the model is evaluated and the values of its variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network, a recurrent neural network, or another type of neural network. A neuron is an architectural element used in data processing and artificial intelligence, particularly machine learning which includes memory that may determine when to “remember” and when to “forget” values held in that memory based on the weights of inputs provided to the given neuron. An example type of neuron in the neural network 320 is a Long Short Term Memory (LSTM) node. Each of the neurons used herein are configured to accept a predefined number of inputs from other neurons in the network to provide relational and sub-relational outputs for the content of the frames being analyzed. Individual neurons may be chained together and/or organized into tree structures in various configurations of neural networks to provide interactions and relationship learning modeling for how each of the frames in an utterance are related to one another.

For example, an LSTM serving as a neuron includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of nonlinear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a predetermined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

The transformer architecture processes an entire input at once rather than sequentially. For example, a RNN processes words or sentences sequentially, with the output of the RNN treated as an input for each input after the first (thus the use of the word “recurrent” in the name). As a result, relationships between elements that are far apart in the input are difficult to detect. The transformer architecture receives a larger input and learns the interrelationships between the elements and the output using an attention mechanism. Since all elements are processed together, distance between the elements of the input does not affect the learning process. The output may still be generated sequentially, with the previous result (e.g., word for an LLM, pixel for an image-generating AI, and the like) being provided as an input for determining the next result.

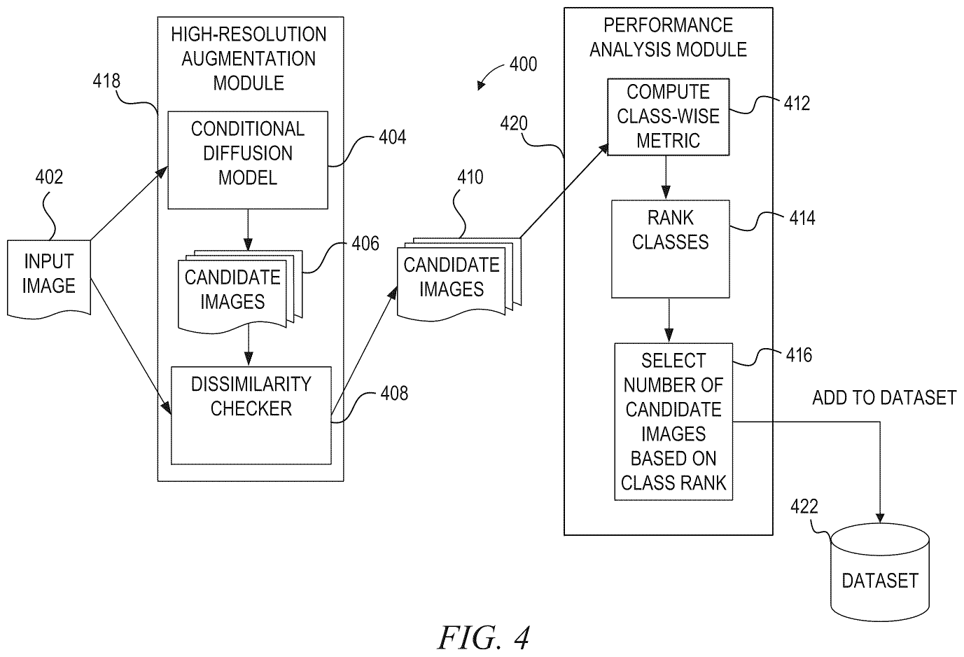

FIG. 4 is a diagrammatic representation of a dataset expansion pipeline 400, according to some examples. The dataset expansion pipeline 400 shows interconnected components and data items that enable image generation, validation, and subsequent filtering for effective expansion. By way of example and not limitation, aspects of the dataset expansion pipeline 400 may be implemented by the components, systems, or elements shown in FIGS. 1-3.

In the example of FIG. 4, the dataset expansion pipeline 400 is implemented using a high-resolution augmentation module (HRAM) 418 and a performance analysis module 420. The HRAM 418 is an implementation of the image generation component 202 of the dataset expansion system 134 of FIGS. 1-2. As shown in FIG. 4, the HRAM 418 triggers execution of a conditional diffusion model 404 to generate images from the input image 402. To this end, the conditional diffusion model 404 may be implemented by a neural network, such as that shown in FIG. 3.

The dataset expansion pipeline 400 takes, as inputs, a plurality of input images, and generates new images based on the input images. For each input image 402, the conditional diffusion model 404 generate candidate images 406. The conditional diffusion model 404 may accept input images of one size (e.g., 32 by 32 pixels) and generate output images of another size (e.g., 512 by 512 pixels).

In some examples, the conditional diffusion model 404 is pretrained on a dataset that includes the input images. The conditional diffusion model 404 has thus learnt the distribution of the input images it handles in the dataset expansion pipeline 400. As an example, the conditional diffusion model 404 generates five candidate images per input image 402. However, this number is selectable or adjustable based on various factors, such as scarcity or imbalance in an initial dataset.

The candidate images 406 are automatically fed into the dissimilarity checker 408, which determines if the candidate images 406 differ by more than a predetermined threshold from the input image 402. Thus, the dissimilarity checker 408 may be used to determine which of the candidate images 406 are OOD images. In an example, the dissimilarity checker 408 calculates a perceptual distance score between each of the candidate images 406 and the input image 402. Images exceeding a predetermined similarity threshold are filtered out by the dissimilarity checker 408.

In this way, and as shown in FIG. 4, the dissimilarity checker 408 starts with the candidate images 406 and then, after discarding the OOD images, generates candidate images 410. The candidate images 410 are of the same class as the input image 402.

The candidate images 410 are provided to the performance analysis module 420. The performance analysis module 420 computes a class-wise performance metric 412 for each class of image being processed by a machine-learning model. The class-wise performance metrics for the classes are compared, resulting in a ranking 414 of the performance of the machine-learning model on each class. Based on the ranking 414, the performance analysis module 420 selects 416 a number of candidate images from the candidate images 410. The selected images are added to the dataset 422 for use in training the machine-learning model.

In some example embodiments, the selected number of images for a class is based on the ranking quartile of the class. In an example, for the first (lowest-performing) quartile of classes, all of the candidate images 410 generated from input images 402 in the class are added to the dataset 422; for the second quartile, 75% of such images are added to the dataset 422; for the third quartile, 50% of such images are added to the dataset 422; and for the fourth (highest-performing) quartile of classes, 25% of the candidate images 410 generated from input images 402 in the class are added to the dataset 422.

At least some of the components shown in FIG. 2 or FIG. 4 may be configured to communicate with each other to implement aspects described herein. One or more of the components described herein may be implemented using hardware (e.g., one or more processors of one or more machines) or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

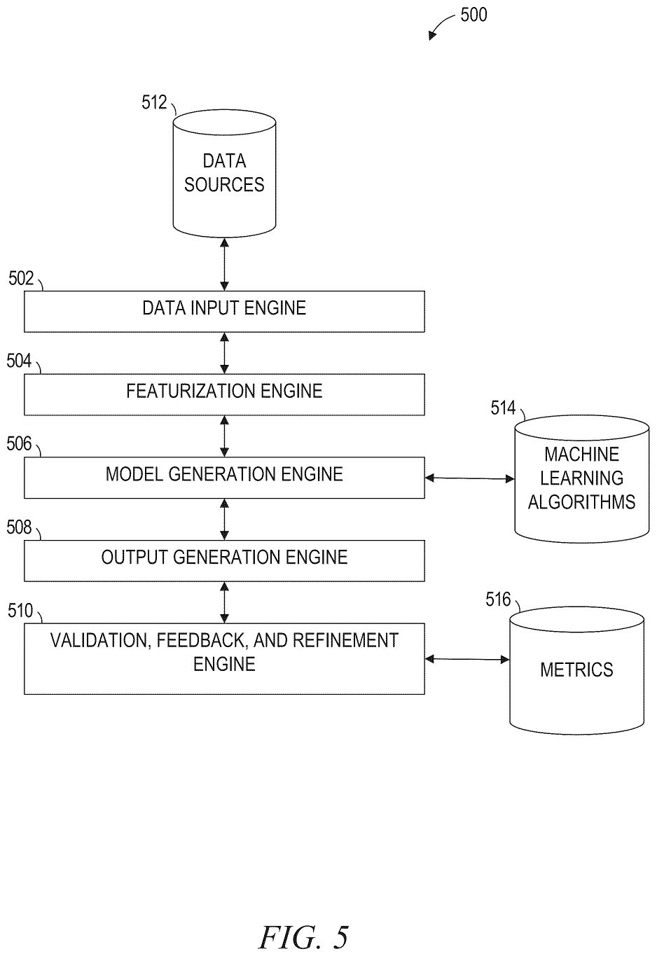

FIG. 5 illustrates a machine learning system 500, according to some examples. The machine learning system 500 may be used to implement aspects of the present disclosure. The machine learning system 500 is shown to include a data input engine 502, a featurization engine 504, a model generation engine 506, an output generation engine 508, and a validation, feedback, and refinement engine 510.

The data input engine 502 may be configured to access, interpret, request, format, re-format, or receive input data from data sources 512. Data sources 512 may include training data (e.g., data for training machine learning models), validation data (e.g., data for comparing model output with known results to evaluate performance), or reference data (e.g., data used to establish baselines or inform model creation). The data input engine 502 can interact with external data systems via input/output (I/O) devices, network interfaces, or storage elements to ensure input data is processed and stored in a suitable format for further operations.

The featurization engine 504 may be configured to transform input data into features that are optimized or useful for machine learning. The featurization engine 504 can handle feature extraction, scaling, or selection, enabling the machine learning system 500 to identify and process relevant data attributes for subsequent modeling. For example, features extracted from raw data may be annotated, labeled, or transformed into numerical representations suitable for machine learning algorithms 514. The featurization engine 504 can work iteratively with other components to refine features based on model requirements or outcomes.

The model generation engine 506 is responsible for creating, training, and configuring one or more machine learning models based on input data and selected features. The model generation engine 506 may include functionality for model selection, hyperparameter tuning, or algorithm implementation.

Machine learning broadly involves using computer algorithms to automatically learn patterns and/or relationships in data, often without the need for explicit programming. Thus, the machine learning algorithms 514 may include various algorithms, including supervised, unsupervised, or reinforcement learning approaches, such as decision trees, neural networks, Support Vector Machines (SVMs), or deep learning architectures such as transformers or Convolutional Neural Networks (CNNs). The model generation engine 506 may also support iterative model refinement and validation cycles, enabling adaptability to evolving data or performance criteria.

In some examples, the output generation engine 508 is responsible for model inference. The output generation engine 508 processes data to produce predictions, classifications, or other results. The output generation engine 508 can also apply post-processing techniques such as aggregation, thresholding, or confidence scoring to ensure outputs are in a format suitable for downstream systems or user interpretation.

The validation, feedback, and refinement engine 510 may be configured to validate, monitor, or improve the performance and relevance of machine learning models over time. The validation, feedback, and refinement engine 510 can apply validation data to assess model outputs and integrates feedback from users or automated systems to improve models. Metrics 516 may be used to evaluate and compare model outputs against validation data or other useful data, providing insights into model performance, accuracy, reliability, or generalization. Refinement operations may involve retraining models with updated data or adjusting model parameters to account for changing conditions or newly observed patterns.

Components of the machine learning system 500 may be implemented by hardware processors and may communicate via network interfaces or shared storage elements to facilitate data exchange and coordination. The architecture shown in FIG. 5 allows for flexible deployment across various machine learning applications, such as natural language processing, computer vision, or predictive analytics.

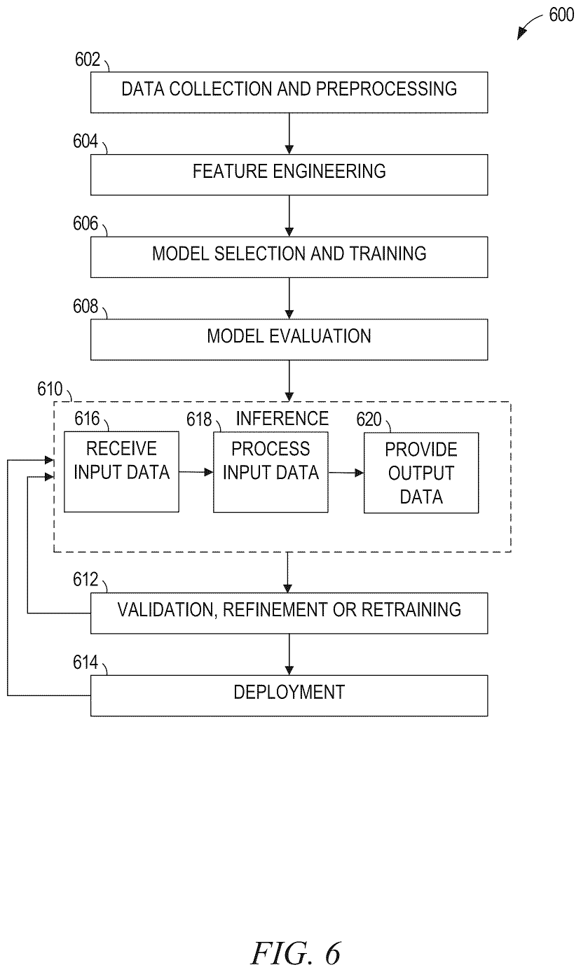

FIG. 6 is a flowchart depicting a machine learning pipeline 600, according to some examples. The machine learning pipeline 600, or parts thereof, may be used to generate a trained machine learning model for use in examples of the present disclosure. In some examples, a system such as the machine learning system 500 of FIG. 5 is used to implement the machine learning pipeline 600.

The machine learning pipeline 600 commences with a data collection and preprocessing stage 602, in which data is acquired, cleaned, or formatted for compatibility with machine learning algorithms. The data collection and preprocessing stage 602 may also involve addressing issues such as duplicate entries, missing values, or data inconsistencies.

During a feature engineering stage 604, training data can be formatted, transformed, or selected as needed to create features that are useful for predicting target data. Feature engineering may include (1) receiving features (e.g., as structured or labeled data in supervised learning) and/or (2) identifying features (e.g., unstructured or unlabeled data for unsupervised learning) in training data. In this context, a feature may be a variable or attribute, such as a measurable property of a process, article, system, or phenomenon represented by a data set. Features may also be of different types, such as numeric features, strings, and graphs, and may include one or more of content, concepts, attributes, historical data, or user data, merely for example.

A model selection and training stage 606 can include selecting an appropriate machine learning algorithm or strategy and training the relevant model on training data. The model selection and training stage 606 may involve splitting the data into training and testing sets, using cross-validation to evaluate the model, and tuning hyperparameters to improve performance. During training, the model may be trained to find features that affect a predicted outcome. The result of the training is a trained machine learning model.

In some examples, techniques such as model quantization, pruning, or knowledge distillation can reduce the computational complexity of a trained model. Quantization involves reducing the precision of weights and activations (e.g., from 32-bit floating-point to 8-bit integers), enabling efficient deployment on hardware-constrained environments such as edge devices. Pruning removes redundant or non-contributory connections within a model, thereby reducing memory and processing requirements. Knowledge distillation transfers the learned knowledge of a large, complex model into a smaller, lightweight model.

A model evaluation stage 608 may include evaluating the performance of a trained model on a separate testing dataset. This can help determine if the model is overfitting or underfitting and determine whether the model is suitable for deployment. Regularization techniques, such as dropout or L2 regularization, may also be employed to prevent overfitting and improve generalization.

FIG. 6 further shows an inference stage 610, in which a trained model generates outputs on new, unseen data. For example, for each input, at operation 616, the model receives input data (e.g., from external sources, such as real-time sensors, databases, or user-provided queries, or internal sources such as test inputs). At operation 618, the trained model processes the input data. This can include various operations that are performed to arrive at output data, such as feature extraction, transformation, and embedding generation, depending on the model architecture. For example, a CNN may process input images by applying convolutional filters, while a transformer model might encode textual input using self-attention mechanisms. The trained model may perform inference, mapping inputs to outputs, such as predictions or classifications, thereby providing the output data at operation 620.

It is noted that output data may take various forms. In classification AI examples, outputs may include data classifications or probabilities linked to particular classifications. In generative AI examples, outputs may include new content, such as translations, summaries, answers, new media content, or combinations thereof. In some examples, outputs are further processed into usable output, such as probabilities, labels, or continuous values tailored for downstream systems. Post-processing may include confidence scoring, aggregation, or error correction, to ensure outputs are accurate and actionable for the intended application.

The machine learning pipeline 600 may also include a validation, refinement, or retraining stage 612. This may include updating a model based on feedback generated from the inference stage 610, such as new data or user feedback. In some examples, validation is performed using a separate dataset known as the validation dataset. The validation dataset can be used to tune or fine-tune the hyperparameters of a model, such as the learning rate and the regularization parameter. The hyperparameters may be adjusted to improve the model's performance on the validation dataset.

During deployment stage 614, the trained model is integrated into or connected with a more extensive or real-world system, application, or environment, such as a web service, mobile app, or Internet of Things (IoT) device. This phase can involve setting up APIs, building a user interface, and ensuring that the model is scalable and can handle large volumes of data. In some examples, the trained model is deployed on a single device, such as locally on an end user's computing device or on an edge device, as opposed to being deployed on a server system. This may provide lower latency or offline functionality in certain scenarios. Accordingly, various trained models can be deployed as server-based deployments or on-device deployments.

In some examples, a trained model includes one or more neural networks. The neural network may include a hierarchical (e.g., layered) organization of neurons or nodes, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

A neural network can be applied in various scenarios. In some cases, the neural network is configured to perform an image or video processing task. For example, the task may be image classification. As another example, the task can be image embedding generation and the output generated by the neural network can be a numeric embedding of the input image. As yet another example, the task can be object detection, and the output generated by the neural network can identify locations in the input image at which particular types of objects are depicted. As another example, if the input to the neural network is a sequence of text in one language, the output generated by the neural network may be a piece of text in the other language that is a predicted proper translation of the input text into the other language.

In some cases, a machine learning task is a multi-modal processing task that requires processing multi-modal data. In general, multi-modal data is a combination of two or more different types of data, e.g., two or more of audio data, image data, text data, or graph data. As one example, the multi-modal data may comprise audio-visual data, comprising a combination of pixels of an image or of video and audio data representing values of a digitized audio waveform. As another example, the multi-modal data may comprise a combination of text data representing text in a natural language and pixels of an image.

In some examples, the neural network may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

As mentioned, a generative AI model can generate new content. For example, generative AI can produce text, images, video, audio, code, or synthetic data. In some examples, the generated content may be similar to original data, but not identical.

Some of the techniques or architectures that may be used in generative AI are GANs, Variational Autoencoders (VAEs), and transformers. GANs may include two neural networks: a generator and a discriminator. The generator network attempts to create realistic content that can “fool” the discriminator network, while the discriminator network attempts to distinguish between real and fake content. The generator and discriminator networks compete with each other and improve over time. VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models may use attention mechanisms to learn the relationships between different parts of input data (such as words or pixels) and generate output data based on these relationships. In some examples, transformer models can handle sequential data, such as text or speech, as well as non-sequential data, such as images or code.

A diffusion model is an example of a generative model that can be used to generate synthetic images for use in examples of the present disclosure. A diffusion model is trained to iteratively denoise an image by reversing a diffusion process. Starting with randomly sampled noise, for example, a trained diffusion model can iteratively denoise data to yield a final image sample.

For instance, Stable Diffusion provides an architecture including a U-Net backbone with approximately 1 billion parameters, utilizing skip connections to enhance feature propagation. The U-Net architecture has multiple layers, employing ReLU (Rectified Linear Unit) activation functions and multi-head attention mechanisms. Connections within the model include convolutional layers and dilated convolutions.

In some examples, a diffusion model is trained by employing stochastic gradient descent (SGD) with a learning rate schedule defined by a cosine annealing strategy. The objective is to minimize a denoising loss function, which measures the difference between predicted and true noise in the input.

The training data used for training a diffusion model can be sourced from publicly available image datasets, such as LAION-5B, ImageNet, or CIFAR. In some examples, the training data is specific to an entity, application, or use case. For example, a diffusion model can be trained on an initial dataset of labeled images, with the intention being to expand the initial dataset without significantly deviating from the original data distribution, as described in the present disclosure. In a manufacturing context, for example, the diffusion model can be trained on a collection of images depicting either defective or non-defective products or parts.

The training data may include representative variations of the relevant parameters, such as image resolutions, noise levels, and content diversity. Input data to the diffusion model may include noisy image tensors, and output of the diffusion model represents denoised image tensors approximating high-quality, clean versions of input images. In some examples, training data undergoes validation to ensure quality and representativeness. This includes checks for missing values, outliers, and duplicates. For example, outlier detection is performed using a z-score analysis, and invalid data points are excluded. Data augmentation techniques, such as random cropping, flipping, and rotation, are applied to enhance data diversity.

A diffusion model can be trained to generate images based on multiple inputs, such as image and text input (e.g., an input image and a class label in text format). Such inputs serve as structural guidance. In some examples, the model is designed to integrate these inputs as conditioning signals during the denoising process. Each guidance input, such as a text description, a masked image, or a segmentation map, is encoded into a shared latent space using appropriate encoders. These encoded representations are combined and injected into the diffusion process, steering the model to generate outputs that adhere to the provided structural constraints. The model is trained with a loss function that ensures the generated output matches the target while maintaining consistency with all guidance inputs.

For example, to train a diffusion model to generate an image based on both an input image and a text description, the model can be designed to learn a mapping from a combined input space to a target image space. During training, the input image and text description are encoded into a shared latent space using encoders, such as a CNN for images and a transformer or recurrent network for text. The latent representations are fused and conditioned into the diffusion process, which iteratively denoises random noise into a high-quality output image.

A diffusion model can be deployed in various environments, including cloud, on-premises, or edge devices. Deployment considerations include optimizing for latency and throughput, ensuring compatibility with container orchestration platforms such as Kubernetes, and adhering to security standards.

A ResNet model is an example of an image classifier model that can be used to process images and output classifications (e.g., class labels) for use in examples of the present disclosure. This type of model can include a sequence of residual blocks to facilitate gradient flow during training. For instance, the ResNet50 architecture has 50 layers, including convolutional layers with ReLU activations, batch normalization, and shortcut connections. ResNet50 can be divided into four main parts: the convolutional layers, the identity block, the convolutional block, and the fully connected layers. The convolutional layers are responsible for extracting features from the input image, while the identity block and convolutional block are responsible for processing and transforming these features. Finally, the fully connected layers are used to make the final classification. Alternative models, such as ViT, use a different architecture consisting of transformer encoders with self-attention mechanisms to model global image dependencies.

The ResNet model can be trained using supervised learning techniques. In some examples, the training data used for this process is sourced from publicly available datasets such as ImageNet or CIFAR. As mentioned with reference to the diffusion model above, in some examples, the training data is specific to an entity, application, or use case. Input data to the model may include RGB images resized to a fixed resolution. The output of the model may represent a probability distribution over the target classes. In some examples, the model generates outputs such as class probabilities or a top-5 prediction list, which can be formatted as objects or graphical labels. Postprocessing may include applying a softmax function to ensure that the predicted probabilities sum to 1.

An image classifier model, such as ResNet, can be deployed in various environments, including cloud, on-premises, or edge devices. Deployment considerations include optimizing for latency, throughput, and memory efficiency.

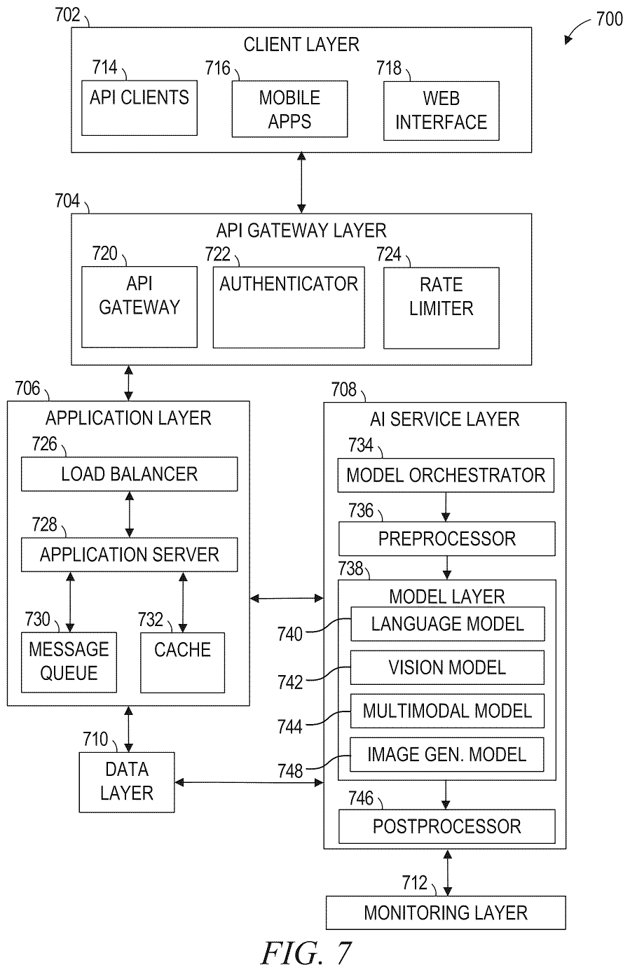

FIG. 7 is a system architecture diagram showing a layered view of an AI integrated system 700, according to some examples. The AI integrated system 700 comprises six example layers: a client layer 702, an API gateway layer 704, an application layer 706, an AI service layer 708, a data layer 710, and a monitoring layer 712.

The client layer 702 provides multiple access points for system interaction. It includes API clients 714, which may enable programmatic access to the capabilities of the AI integrated system 700 or integration with third-party systems and services. Mobile applications 716 facilitate access from mobile applications and devices, for example implementing native mobile protocols while maintaining consistent communication patterns with backend systems. A web interface 718 enables browser-based access to the capabilities of the AI integrated system 700 and may communicate with other layers using, for example, Hypertext Transfer Protocol (HTTP) or Hypertext Transfer Protocol Secure (HTTPS) protocols.

The API gateway layer 704 serves as an entry point for client communications. The API gateway layer 704 comprises an API gateway 720, which may implement routing logic to direct incoming requests to appropriate backend services. An authenticator 722 validates client credentials, for example using industry-standard protocols, such as OAuth 2.0 (Open Authorization 2.0) or JWT (JSON Web Tokens). In some examples, a rate limiter 724 of the API gateway layer 704 operates to prevent system abuse or ensure resource allocation among clients.

The application layer 706 comprises various processing capabilities. In some examples, the application layer 706 includes a load balancer 726 that may distribute incoming requests across multiple application server instances to support resource utilization and system reliability. An application server 728 may implement business or core functional logic of the AI integrated system 700, processing requests and coordinating responses across various system components. In some examples, a message queue 730 facilitates asynchronous processing capabilities, enabling efficient handling of operations, and a cache 732 operates within the application layer 706 to improve response times for frequently requested data.

The AI service layer 708 provides AI capabilities through a structured approach to model deployment and execution. In some examples, the AI service layer 708 includes a model orchestrator 734 that coordinates the execution of one or various AI models, managing resource allocation and implementing routing logic to direct requests to appropriate model instances. A preprocessor 736 may prepare input data for model consumption, implementing transformations, validations, or other preprocessing operations.

FIG. 7 shows the AI service layer 708 as including a model layer 738. The model layer 738 may include multiple model types, including, for example, one or more of: a language model 740 for processing textual input, implementing natural language processing capabilities; a vision model 742 for handling image or video processing tasks; a multimodal model 744 that combines multiple input types to provide comprehensive analysis capabilities; and an image generation model 748 that is specifically trained for automated image generation. In some examples, a postprocessor 746 of the AI service layer 708 transforms model outputs into standardized formats suitable for client consumption. The data layer 710 provides persistent storage capabilities.

While not detailed in FIG. 7, it is noted that the data layer 710 may include various components such as a primary database for maintaining transactional data, a vector database for optimizing storage and retrieval of high-dimensional vectors used in AI applications and models of the AI service layer 708, or a file storage component for managing binary data assets.

The monitoring layer 712 may provide observability capabilities across the AI integrated system 700. This may include logging for capturing system events, metrics collection for performance analysis, or distributed tracing for detailed analysis of request flow through the system.

Communication between layers of the AI integrated system 700 may follow defined patterns. External communications may implement appropriate encryption protocols, for example utilizing Transport Layer Security (TLS) or Secure Sockets Layer (SSL) for data protection. Internal communications may use various protocols selected for specific use cases, for example, Hypertext Transfer Protocol version 2 (HTTP/2), gRPC (Google Remote Procedure Call), or proprietary protocols where appropriate.

Referring again to the model layer 738, this layer may incorporate various types of machine learning models. Neural networks may be deployed to implement various architectures suited to specific processing needs. These can include, merely for example, fundamental feedforward neural networks for pattern recognition, CNNs that may be specialized for processing visual information, RNNs that may be designed for sequential data, transformer networks, or other architectures.

A language model such as the language model 740 may use transformer-based architectures (e.g., Bidirectional Encoder Representations from Transformers (BERT), Generative Pre-trained Transformer (GPT) variants, or Text-to-Text Transfer Transformer (T5)) for processing textual data and implementing natural language understanding capabilities. A vision model such as the vision model 742 may employ specialized neural network architectures (e.g., CNNs, ViT, or ResNet variants) for processing visual information and extracting features from images or video streams. A multimodal model such as the multimodal model 744 may implement hybrid architectures (e.g., Contrastive Language-Image Pre-training (CLIP), DALL-E variants, or multimodal transformers) designed to process and correlate information across different input modalities, leveraging ensemble approaches to combine multiple model types using model aggregation or weighted prediction strategies. A multimodal model may combine textual, visual, and other forms of input data to provide analysis and generate integrated outputs that leverage cross-modal understanding capabilities. A dedicated image generator such as the image generation model 748 may, for example, be based on a diffusion model architecture (e.g., Stable Diffusion).

The AI service layer 708 may provide both supervised learning models (e.g., decision trees, random forests, or support vector machines) for specific classification and prediction tasks, and unsupervised learning models (e.g., k-means clustering or principal component analysis) for pattern discovery and dimensionality reduction within the data processing pipeline. Probabilistic models (e.g., Bayesian networks or hidden Markov models) may be integrated within the AI service layer 708 to handle uncertainty in decision-making processes, working in conjunction with the preprocessor 736 and postprocessor 746 components to provide probability estimates and confidence metrics for model outputs.

Each model type may be implemented using various deployment strategies, with the model orchestrator 734 managing their execution and resource allocation to ensure adequate performance and efficient system operation. This may include coordinating the deployment and execution of various model types, ensuring efficient resource allocation, and appropriate model selection based on specific task requirements. While in some examples the model layer 738 provides server-based access to one or more models, a model can alternatively (or additionally) be deployed so as to perform inference locally (e.g., at the client layer 702).

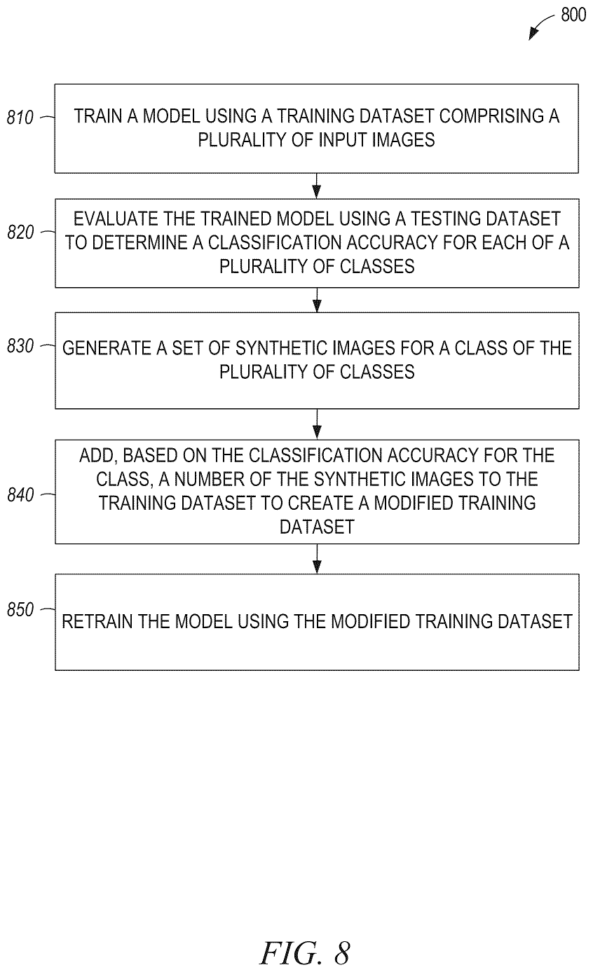

FIG. 8 is a flowchart illustrating a method 800 of boosting underperforming classes using synthetic data, according to some examples. The method 800 includes operations 810, 820, 830, 840, and 850. By way of example and not limitation, the method 800 is described as being performed by the dataset expansion system 134 and the machine learning system 136 of FIGS. 1-2, using the neural network 320 shown in FIG. 3.

In operation 810, the machine learning system 136 trains a model using a training dataset comprising a plurality of input images. The trained model is evaluated using a testing dataset to determine a classification accuracy for each of a plurality of classes (operation 820). In some example embodiments, the training dataset and the testing dataset comprise labeled images, with the label for each image indicating a class of the image. During training, the model learns from the classification of the images of the training dataset. During evaluation, the model uses its learning to predict the class of the images of the testing dataset. The classification accuracy for each class may be determined as the percentage of each class that is correctly classified by the trained model during testing. For example, images of dogs may be correctly classified 80% of the time; images of cats may be correctly classified 90% of the time; and images of vehicles may be correctly classified 70% of the time.

The dataset expansion system 134 generates, in operation 830, a set of synthetic images for a class of the plurality of classes. In some example embodiments, the HRAM 418 uses the conditional diffusion model 404 to generate the candidate images 406 for each input image 402 (all shown in FIG. 4) in the training dataset. In such example embodiments, the dataset expansion system 134 generates a set of synthetic images for all classes of the plurality of classes of images in the training dataset. The generating of the set of synthetic images may include generating the synthetic images at a higher resolution than the input images.

To ensure quality, a similarity analysis may filter out generated images that significantly deviate from the original dataset. This filtering uses a decision threshold (e.g., an LPIPS score above 0.05) to eliminate irrelevant or inconsistent images caused by issues like misclassification or hallucination during generation. This step maintains a balance between diversity and data consistency, minimizing distribution shifts while ensuring compatibility with the original dataset. The high-resolution images that pass the filter are then selectively integrated into the training pipeline through the performance analysis module 420 of FIG. 4. Thus, in some example embodiments, the dataset expansion system 134 generates, for each synthetic image of the set of synthetic images, a value indicative of similarity between the synthetic image and the class and compares the value with a predetermined threshold to determine whether to remove the synthetic image.

In operation 840, the dataset expansion system 134 adds, based on the classification accuracy for the class, a number of the synthetic images to the training dataset to create a modified training dataset. For example, the classification accuracies for the classes may be ranked. Fewer images for classes with higher-ranked accuracies are added to the training dataset and more images for classes with lower-ranked accuracies are added to the training dataset. As a result, the lower-performing classes will have more images added to the training dataset, giving the model additional chances to learn how to properly classify images of those classes. The modified training dataset comprises, for added synthetic image, the class label for an input image that was used to generate the synthetic image.

The machine learning system 136, in operation 850, retrains the model using the modified training dataset, thereby improving the functioning of the model, and of computer systems that use the model to perform image classification.

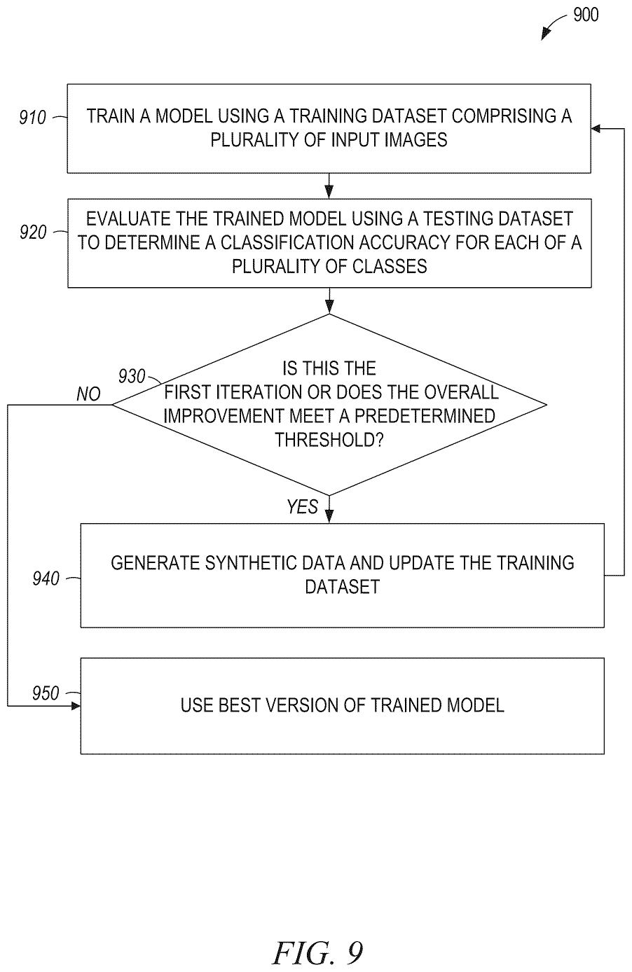

FIG. 9 is a flowchart illustrating a method 900 of boosting underperforming classes using synthetic data, according to some examples. The method 900 includes operations 910, 920, 930, 940, and 950. By way of example and not limitation, the method 800 is described as being performed by the dataset expansion system 134 and the machine learning system 136 of FIGS. 1-2, using the neural network 320 shown in FIG. 3.

In operation 910, the machine learning system 136 trains a model using a training dataset comprising a plurality of input images. The trained model is evaluated using a testing dataset to determine a classification accuracy for each of a plurality of classes (operation 920).

Since this is a first iteration of operations 910 and 920, the method 900 proceeds with operation 940. In operation 940, the data expansion system 340 generates synthetic data and updates the training dataset. For example, operation 940 may include operations 830 and 840 of FIG. 8.

After the training dataset is updated, the method 900 returns to operation 910, retraining the model using the updated training dataset. In different iterations, different classes may underperform. As a result, different numbers of images will be added to the training dataset in different iterations for the same class. For example, in a first iteration, Class A may be in lowest-performing quartile and, based on this, all synthetic images generated from images in Class A are added to the training dataset in the first iteration. In a second iteration, Class A may be in the highest-performing quartile and, based on this, only 25% of synthetic images generated from images in Class A are added to the training dataset in the second iteration.

The resulting model is evaluated in operation 920. In operation 930, the evaluation of the retrained model is compared to the evaluation of the previous version of the model. If the retrained model has improved by at least a predetermined threshold by comparison with the previous model, the method 900 proceeds to perform another iteration, generating additional synthetic data (operation 940), retraining the model (operation 910), evaluating the new model (operation 920), and determining whether the model has improved sufficiently (operation 930). In subsequent iterations, some synthetic data will be generated based on images generated in previous iterations. The generated images may be at a higher resolution than the original images. To handle this, larger images may be downsampled to a standard size (e.g., downsampled from 512 pixels by 512 pixels to 32 pixels by 32 pixels) before being used to generate new synthetic data.

Thus, as long as the addition of synthetic data is improving the ability of the model to classify images in the testing dataset, operations 910-940 are repeated. Once the model ceases to improve, the method 900 proceeds to operation 950, in which the best version of the trained model is used. Typically, the best version of the trained model will be the last version generated. However, it is possible for performance of the model to decline during the iteration process. Accordingly, if a previous version had better performance than the last-created version, the better-performing previous version will be used in operation 950.

By comparison with systems that train a machine learning model using a training dataset without synthetic data supplementation, the resulting trained model from the use of the method 900 has improved classification accuracy, thereby improving the functioning of a computer itself.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.
Example 1 is a system comprising: at least one hardware processor; and a non-transitory computer-readable medium storing instructions that, when executed by the at least one hardware processor, cause the at least on hardware processor to perform operations comprising: training a model using a training dataset comprising a plurality of input images; evaluating the trained model using a testing dataset to determine a classification accuracy for each of a plurality of classes; generating a set of synthetic images for a class of the plurality of classes; adding, based on the classification accuracy for the class, a number of the synthetic images to the training dataset to create a modified training dataset; and retraining the model using the modified training dataset.
In Example 2, the subject matter of Example 1, wherein the operations further comprise: for each synthetic image of the set of synthetic images, generating a value indicative of similarity between the synthetic image and the class; and comparing the value with a predetermined threshold to determine whether to remove the synthetic image.
In Example 3, the subject matter of Example 2, wherein the value is a perceptual distance score.
In Example 4, the subject matter of Examples 1-3, wherein: the training dataset comprises the plurality of input images and a corresponding class label for each of the plurality of input images; and the modified training dataset comprises, for added synthetic image, the class label for an input image that was used to generate the synthetic image.
In Example 5, the subject matter of Examples 1-4, wherein the generative model comprises a diffusion model.
In Example 6, the subject matter of Examples 1-5, wherein the operations further comprise: determining a first score for the trained model based on the classification accuracy; evaluating the retrained model using the testing dataset to determine a revised classification accuracy for each of the plurality of classes; determining a second score for the retrained model based on the revised classification accuracy; and determining whether to generate further synthetic images based on the first score and the second score.
In Example 7, the subject matter of Examples 1-6, wherein the generating of the set of synthetic images comprises generating the synthetic images at a higher resolution than the input images.
In Example 8, the subject matter of Examples 1-7, wherein the number of the synthetic images added to the training dataset is selected based on a quartile of the classification accuracy for the class.
Example 9 is one or more non-transitory computer-readable media storing computer-executable instructions that, when executed by a computing system, cause the computing system to perform operations comprising: training a model using a training dataset comprising a plurality of input images; evaluating the trained model using a testing dataset to determine a classification accuracy for each of a plurality of classes; generating a set of synthetic images for a class of the plurality of classes; adding, based on the classification accuracy for the class, a number of the synthetic images to the training dataset to create a modified training dataset; and retraining the model using the modified training dataset.
In Example 10, the subject matter of Example 9, wherein the operations further comprise: for each synthetic image of the set of synthetic images, generating a value indicative of similarity between the synthetic image and the class; and comparing the value with a predetermined threshold to determine whether to remove the synthetic image.
In Example 11, the subject matter of Example 10, wherein the value is a perceptual distance score.
In Example 12, the subject matter of Examples 9-11, wherein: the training dataset comprises the plurality of input images and a corresponding class label for each of the plurality of input images; and the modified training dataset comprises, for added synthetic image, the class label for an input image that was used to generate the synthetic image.
In Example 13, the subject matter of Examples 9-12, wherein the generative model comprises a diffusion model.
In Example 14, the subject matter of Examples 9-13, wherein the operations further comprise: determining a first score for the trained model based on the classification accuracy; evaluating the retrained model using the testing dataset to determine a revised classification accuracy for each of the plurality of classes; determining a second score for the retrained model based on the revised classification accuracy; and determining whether to generate further synthetic images based on the first score and the second score.
In Example 15, the subject matter of Examples 9-14, wherein the generating of the set of synthetic images comprises generating the synthetic images at a higher resolution than the input images.
In Example 16, the subject matter of Examples 9-15, wherein the number of the synthetic images added to the training dataset is selected based on a quartile of the classification accuracy for the class.
Example 17 is a method comprising: training, by one or more hardware processors, a model using a training dataset comprising a plurality of input images; evaluating the trained model using a testing dataset to determine a classification accuracy for each of a plurality of classes; generating a set of synthetic images for a class of the plurality of classes; adding, based on the classification accuracy for the class, a number of the synthetic images to the training dataset to create a modified training dataset; and retraining the model using the modified training dataset.
In Example 18, the subject matter of Example 17 includes, for each synthetic image of the set of synthetic images, generating a value indicative of similarity between the synthetic image and the class; and comparing the value with a predetermined threshold to determine whether to remove the synthetic image.
In Example 19, the subject matter of Example 18, wherein the value is a perceptual distance score.
In Example 20, the subject matter of Examples 17-19, wherein: the training dataset comprises the plurality of input images and a corresponding class label for each of the plurality of input images; and the modified training dataset comprises, for added synthetic image, the class label for an input image that was used to generate the synthetic image.
Example 21 is an apparatus comprising means to implement any of Examples 1-20.

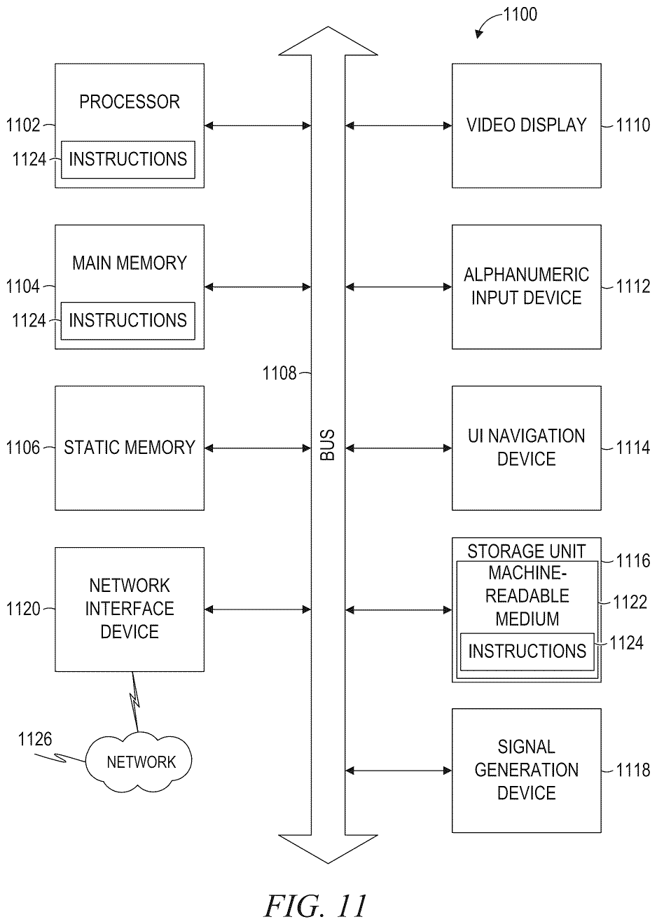

FIG. 10 shows a block diagram 1000 showing one example of a software architecture 1002 for a computing device. The software architecture 1002 may be used in conjunction with various hardware architectures, for example, as described herein. FIG. 10 is merely a non-limiting example of a software architecture, and many other architectures may be implemented to facilitate the functionality described herein. A representative hardware layer 1004 is illustrated and can represent, for example, any of the above referenced computing devices. In some examples, the hardware layer 1004 may be implemented according to the architecture of the computer system of FIG. 11.

The representative hardware layer 1004 comprises one or more processing units 1006 having associated executable instructions 1008. Executable instructions 1008 represent the executable instructions of the software architecture 1002, including implementation of the methods, modules, subsystems, and components, and so forth described herein and may also include memory and/or storage modules 1010, which also have executable instructions 1008. Hardware layer 1004 may also comprise other hardware as indicated by other hardware 1012 which represents any other hardware of the hardware layer 1004, such as the other hardware illustrated as part of the software architecture 1002.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware 1018, applications 1020, and presentation layer 1044. Operationally, the applications 1020 and/or other components within the layers may invoke API calls 1024 through the software stack and access a response, returned values, and so forth illustrated as messages 1026 in response to the API calls 1024. The layers illustrated are representative in nature and not all software architectures have all layers. For example, some mobile or special purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of an interrupt and, in response, cause the software architecture 1002 to pause its current processing and execute an interrupt service routine (ISR) when an interrupt is accessed.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than to interface directly with the underlying operating system 1014 functionality (e.g., kernel 1028, services 1030 and/or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks/middleware 1018 may provide a higher-level common infrastructure that may be utilized by the applications 1020 and/or other software components/modules. For example, the frameworks/middleware 1018 may provide various graphical user interface (GUI) functions, high-level resource management, high-level location services, and so forth. The frameworks/middleware 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a contacts application, a browser application, a book reader application, a location application, a media application, a messaging application, and/or a game application. Third-party applications 1042 may include any of the built-in applications 1040 as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1042 may invoke the API calls 1024 provided by the mobile operating system such as operating system 1014 to facilitate functionality described herein.

The applications 1020 may utilize built-in operating system functions (e.g., kernel 1028, services 1030 and/or drivers 1032), libraries (e.g., system libraries 1034, API libraries 1036, and other libraries 1038), and frameworks/middleware 1018 to create user interfaces to interact with users of the system. Alternatively, or additionally, in some systems, interactions with a user may occur through a presentation layer, such as presentation layer 1044. In these systems, the application/module “logic” can be separated from the aspects of the application/module that interact with a user.

Some software architectures utilize virtual machines. In the example of FIG. 10, this is illustrated by virtual machine 1048. A virtual machine creates a software environment where applications/modules can execute as if they were executing on a hardware computing device. A virtual machine is hosted by a host operating system (operating system 1014) and typically, although not always, has a virtual machine monitor 1046, which manages the operation of the virtual machine 1048 as well as the interface with the host operating system (i.e., operating system 1014). A software architecture executes within the virtual machine 1048 such as an operating system 1050, libraries 1052, frameworks/middleware 1054, applications 1056 and/or presentation layer 1058. These layers of software architecture executing within the virtual machine 1048 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 11 shows a block diagram of a machine in the example form of a computer system 1100 within which instructions 1124 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a CPU, a graphics processing unit (GPU), or both), a main memory 1104, and a static memory 1106, which communicate with each other via a bus 1108. The computer system 1100 may further include a video display unit 1110 (e.g., a liquid crystal display (LCD) or a cathode ray tube [CRT]). The computer system 1100 also includes an alphanumeric input device 1112 (e.g., a keyboard or a touch-sensitive display screen), a user interface navigation (or cursor control) device 1114 (e.g., a mouse), a storage unit 1116, a signal generation device 1118 (e.g., a speaker), and a network interface device 1120.

### Machine-Readable Medium

The storage unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, with the main memory 1104 and the processor 1102 also constituting a machine-readable medium 1122.

While the machine-readable medium 1122 is shown in FIG. 11 to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding, or carrying instructions 1124 for execution by the machine and that cause the machine to perform any one or more of the methodologies of the present disclosure, or that is capable of storing, encoding, or carrying data structures utilized by or associated with the instructions 1124. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1124 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise. As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

What is claimed is:

1. A system comprising:
at least one hardware processor; and
a non-transitory computer-readable medium storing instructions that, when executed by the at least one hardware processor, cause the at least on hardware processor to perform operations comprising:
training a model using a training dataset comprising a plurality of input images;
evaluating the trained model using a testing dataset to determine a classification accuracy for each of a plurality of classes;
generating a set of synthetic images for a class of the plurality of classes;
adding, based on the classification accuracy for the class, a number of the synthetic images to the training dataset to create a modified training dataset; and
retraining the model using the modified training dataset.

2. The system of claim 1, wherein the operations further comprise:
for each synthetic image of the set of synthetic images, generating a value indicative of similarity between the synthetic image and the class; and
comparing the value with a predetermined threshold to determine whether to remove the synthetic image.

3. The system of claim 2, wherein the value is a perceptual distance score.

4. The system of claim 1, wherein:
the training dataset comprises the plurality of input images and a corresponding class label for each of the plurality of input images; and
the modified training dataset comprises, for added synthetic image, the class label for an input image that was used to generate the synthetic image.

5. The system of claim 1, wherein the generative model comprises a diffusion model.

6. The system of claim 1, wherein the operations further comprise:
determining a first score for the trained model based on the classification accuracy;
evaluating the retrained model using the testing dataset to determine a revised classification accuracy for each of the plurality of classes;
determining a second score for the retrained model based on the revised classification accuracy; and
determining whether to generate further synthetic images based on the first score and the second score.

7. The system of claim 1, wherein the generating of the set of synthetic images comprises generating the synthetic images at a higher resolution than the input images.

8. The system of claim 1, wherein the number of the synthetic images added to the training dataset is selected based on a quartile of the classification accuracy for the class.

9. One or more non-transitory computer-readable media storing computer-executable instructions that, when executed by a computing system, cause the computing system to perform operations comprising:
training a model using a training dataset comprising a plurality of input images;
evaluating the trained model using a testing dataset to determine a classification accuracy for each of a plurality of classes;
generating a set of synthetic images for a class of the plurality of classes;
adding, based on the classification accuracy for the class, a number of the synthetic images to the training dataset to create a modified training dataset; and
retraining the model using the modified training dataset.

10. The non-transitory computer-readable media of claim 9, wherein the operations further comprise:
for each synthetic image of the set of synthetic images, generating a value indicative of similarity between the synthetic image and the class; and
comparing the value with a predetermined threshold to determine whether to remove the synthetic image.

11. The non-transitory computer-readable media of claim 10, wherein the value is a perceptual distance score.

12. The non-transitory computer-readable media of claim 9, wherein:
the training dataset comprises the plurality of input images and a corresponding class label for each of the plurality of input images; and
the modified training dataset comprises, for added synthetic image, the class label for an input image that was used to generate the synthetic image.

13. The non-transitory computer-readable media of claim 9, wherein the generative model comprises a diffusion model.

14. The non-transitory computer-readable media of claim 9, wherein the operations further comprise:
determining a first score for the trained model based on the classification accuracy;
evaluating the retrained model using the testing dataset to determine a revised classification accuracy for each of the plurality of classes;
determining a second score for the retrained model based on the revised classification accuracy; and
determining whether to generate further synthetic images based on the first score and the second score.

15. The non-transitory computer-readable media of claim 9, wherein the generating of the set of synthetic images comprises generating the synthetic images at a higher resolution than the input images.

16. The non-transitory computer-readable media of claim 9, wherein the number of the synthetic images added to the training dataset is selected based on a quartile of the classification accuracy for the class.

17. A method comprising:
training, by one or more hardware processors, a model using a training dataset comprising a plurality of input images;
evaluating the trained model using a testing dataset to determine a classification accuracy for each of a plurality of classes;
generating a set of synthetic images for a class of the plurality of classes;
adding, based on the classification accuracy for the class, a number of the synthetic images to the training dataset to create a modified training dataset; and
retraining the model using the modified training dataset.

18. The method of claim 17, further comprising:
for each synthetic image of the set of synthetic images, generating a value indicative of similarity between the synthetic image and the class; and
comparing the value with a predetermined threshold to determine whether to remove the synthetic image.

19. The method of claim 18, wherein the value is a perceptual distance score.

20. The method of claim 17, wherein:
the training dataset comprises the plurality of input images and a corresponding class label for each of the plurality of input images; and
the modified training dataset comprises, for added synthetic image, the class label for an input image that was used to generate the synthetic image.
